(19) United States
(12) Patent Application Publication
(10) Pub. No.: US 2026/0346822 A1
(43) Pub. Date: Nov. 5, 2026

(54) BRAKING SYSTEM

(71) Applicant: BOMBARDIER RECREATIONAL PRODUCTS INC., Valcourt (CA)

(72) Inventors: Benoit SIMARD, Bromont (CA); George PISAU, Valcourt (CA)

(21) Appl. No.: 19/665,443

(22) Filed: May 1, 2026

Related U.S. Application Data
(60) Provisional application No. 63/799,075, filed on May 2, 2025.

(51) Int. Cl. B60T 13/12; B60T 13/74; B60T 17/22

(52) U.S. Cl. CPC B60T 13/12; B60T 13/74; B60T 17/22; B60T 2270/60

(57) ABSTRACT

A braking system includes a brake actuator, first and second brakes, a sensor, and a piston assembly, which includes a housing, a piston disposed within the housing and defining first and second chambers therein, and a biasing element biasing the piston toward a neutral position. The sensor senses a position of the piston and is communicatively connected to the second brake. In response to the brake actuator being actuated, a pressure in a hydraulic circuit, defined by the brake actuator, the first brake, and the piston assembly, increases. In response to the pressure of the hydraulic circuit being greater than a first predetermined pressure, the first brake applies a first braking torque. In response to the pressure of the hydraulic circuit being greater than a second predetermined pressure, the piston is offset from the neutral position, and the second brake applies a second braking torque.

### CROSS-REFERENCE

The present application claims priority to United States Provisional Patent Application No. 63/799,075, filed May 2, 2025, the entirety of which is incorporated herein by reference.

### TECHNICAL FIELD

The present technology relates to braking systems for vehicles.

### BACKGROUND

Conventionally, braking systems for vehicles are hydraulic braking systems. Nowadays, many braking systems provided with vehicles having electric motors and batteries can operate in a regenerative braking mode.

Integration of regenerative braking into a hydraulic braking system can simplify the braking system of a vehicle by reducing the number of components, such as, for example, by using the same braking actuator for both regenerative and friction braking. Additionally, in instances where regenerative braking is unavailable, such as when the battery is fully charged, when the battery temperature is too low to accept a charge, or when a critical regenerative braking component fails, friction braking may be activated by actuating the same braking actuator.

While many braking systems utilize regenerative and friction brake blending, requirements for modern braking systems, such as anti-lock braking systems and stability control, can make brake blending methods complex and costly. These methods can involve mechanical decoupling of the hydraulic friction braking system from the brake actuator, which can increase cost, reduce reliability, and result in an unnatural pedal feel.

In view of the foregoing, there is a need for a braking system that addresses at least some of these drawbacks.

### SUMMARY

It is an object of the present technology to ameliorate at least some of the inconveniences present in the prior art.

According to one aspect of the present technology, there is provided a braking system including: a brake actuator; a first brake hydraulically connected to the brake actuator, the first brake being configured to apply a first braking torque; a piston assembly including: a housing; a piston disposed within the housing, the piston defining: a first chamber in the housing, the first chamber being hydraulically connected to the brake actuator; and a second chamber in the housing, and a biasing element biasing the piston toward a neutral position, a sensor sensing a position of the piston; a second brake communicatively connected to the sensor, the second brake being configured to apply a second braking torque, a hydraulic circuit defined by the brake actuator, the first brake, and the piston assembly, and in response to the brake actuator being actuated, a pressure in the hydraulic circuit increases, in response to the pressure of the hydraulic circuit being greater than a first predetermined pressure, the first brake applies the first braking torque; and in response to the pressure of the hydraulic circuit being greater than a second predetermined pressure, the piston is offset from the neutral position, the second brake applies the second braking torque.

In some embodiments, the first braking torque is variable.

In some embodiments, the first braking torque varies according to the pressure in the hydraulic circuit.

In some embodiments, the second braking torque is variable.

In some embodiments, the second braking torque varies according to a movement of the piston.

In some embodiments, the second braking torque varies proportionally to the movement of the piston.

In some embodiments, the second braking torque varies according to a speed of the piston.

In some embodiments, the second braking torque varies proportionally to the speed of the piston.

In some embodiments, the second predetermined pressure is in part defined by the biasing element.

In some embodiments, the second predetermined pressure is greater than the first predetermined pressure.

In some embodiments, the second predetermined pressure is less than the first predetermined pressure.

In some embodiments, the first brake is a friction brake configured to operatively connect to a wheel.

In some embodiments, the friction brake is a first friction brake, and the braking system further includes a second friction brake hydraulically connected to the brake actuator, the second friction brake being configured to operatively connect to an other wheel.

In some embodiments, the second brake is a motor brake.

In some embodiments, the motor brake includes: an electric motor; an inverter; and a battery, and the second braking torque is applied by the electric motor being operated as a generator to recharge the battery.

In some embodiments, the motor brake includes a motor configured to apply retarding forces.

In some embodiments, the piston has a ferromagnetic element, and the sensor is a Hall-effect sensor for detecting the position of the piston via the ferromagnetic element.

In some embodiments, the biasing element is a spring.

In some embodiments, the biasing element is disposed in the second chamber.

For purposes of the present application, terms related to spatial orientation when referring to a vehicle and components in relation to the vehicle, such as “forwardly”, “rearwardly”, “left”, “right”, “above” and “below”, are as they would be understood by a driver of the vehicle sitting thereon in an upright driving position, with the vehicle steered straight-ahead.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a schematic top plan view of a vehicle having a braking system according to an embodiment of the present technology;

FIG. 2 depicts a schematic cross-sectional view of a piston assembly of the braking system of FIG. 1;

FIG. 3 is a flowchart depicting how one embodiment of the braking system works; and

FIG. 4 is a flowchart depicting how an other embodiment of the braking system works.

### DETAILED DESCRIPTION

The present technology relates to a braking system 100 which will be described with reference to a vehicle 50.

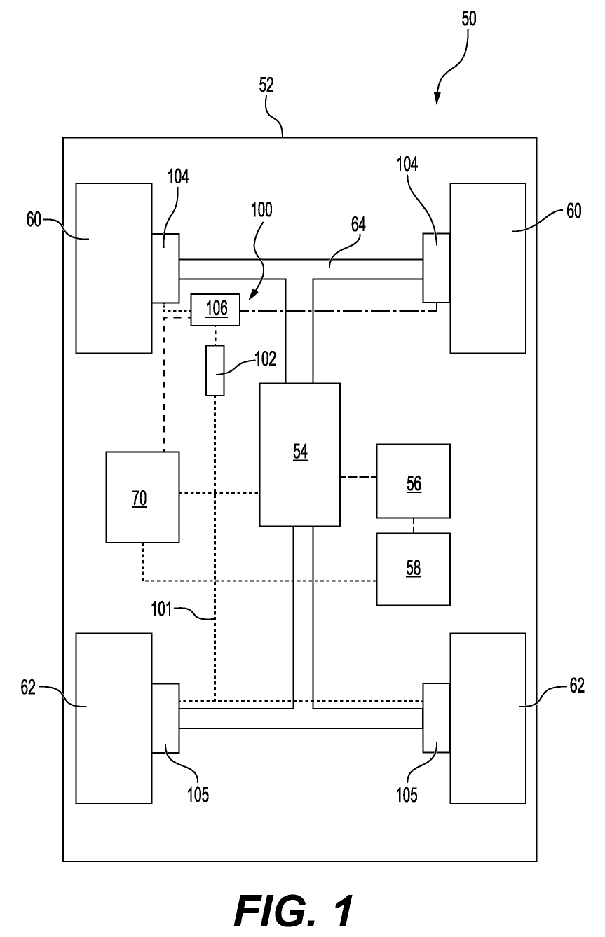

As schematically depicted in FIG. 1, the vehicle 50 is a four-wheeled vehicle 50. It is contemplated that aspects of the present technology could be used in other types of vehicles, such as, for example, two-wheeled or three-wheeled vehicles. In some instances, the four-wheeled vehicle 50 could be a side-by-side vehicle, utility vehicle, or an all-terrain vehicle.

The vehicle 50 has a frame 52 that supports a motor 54 of the vehicle 50. The motor 54 is an electric motor 54. It is contemplated that in other embodiments, the motor 54 may be an internal combustion engine. The vehicle 50 also includes an inverter 56 and a battery 58, both of which are also supported by the frame 52. The battery 58 is electrically connected to the inverter 56, which is electrically connected to the electric motor 54. The battery 58 serves as a power source for the motor 54.

The vehicle 50 further has two front wheels 60 and two rear wheels 62. The front and rear wheels 60, 62 are operatively connected to the motor 54 via a transmission 64. It is contemplated that in some embodiments, only the two front wheels 60 or only the two rear wheels 62 may be operatively connected to the motor 54. It is also contemplated that the transmission 64 may be configurable so that the motor 54 selectively drives all the wheels 60, 62, only the front wheels 60, or only the rear wheels 62. It is also contemplated that the vehicle 50 could have the motor 54 driving the front wheels 60 and a second motor driving the rear wheels 62.

The vehicle 50 further includes a controller 70 that is communicatively connected to the motor 54 and to the battery 58. The controller 70 is configured to regulate power delivery from the battery 58 to the motor 54 during propulsion of the vehicle 50. As will be described below, the controller 70 is also configured to control the motor 54 to act as a motor brake and initiate a motor braking mode for recharging the battery 58.

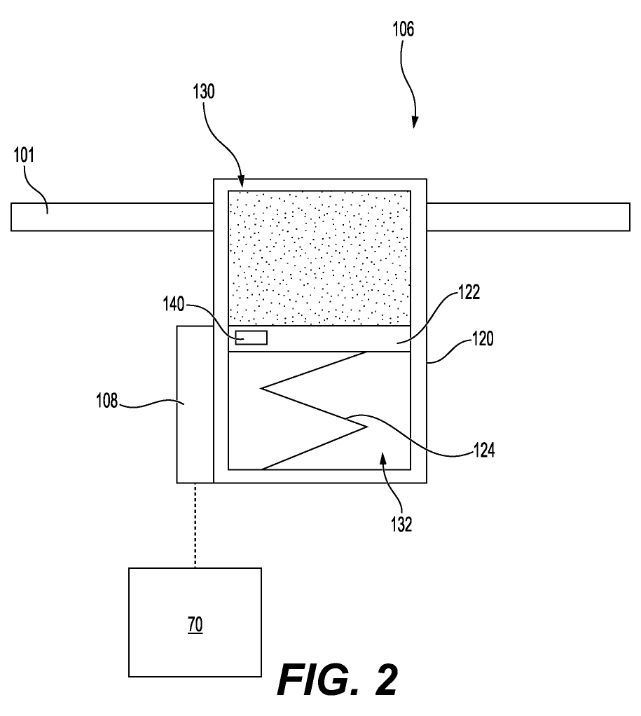

Still referring to FIG. 1, the vehicle 50 also includes the braking system 100. The braking system 100 includes a brake actuator 102, front friction brakes 104, rear friction brakes 105, a piston assembly 106, a sensor 108 (shown in FIG. 2), and the motor 54. The braking system 100 also has a hydraulic circuit 101 that is defined by the brake actuator 102, the front and rear friction brakes 104, 105, and the piston assembly 106. A hydraulic fluid, such as oil, is present in the hydraulic circuit 101. As will be described below, in response to the actuation of the brake actuator 102, a pressure in the hydraulic circuit 101 is increased.

In the present embodiment, the brake actuator 102 is a brake pedal 102 that can be pressed on by a foot of a driver of the vehicle 50 for braking the vehicle 50. It is contemplated that the brake pedal 102 could be another type of brake actuator, such as, for example, a brake lever. The brake actuator 102 includes a master cylinder. In response to a force being applied to the brake actuator 102 by the driver, hydraulic pressure in the hydraulic circuit 101 is increased.

The front and rear friction brakes 104, 105 are hydraulically connected to the brake actuator 102. There are two front friction brakes 104 and two rear friction brakes 105. Each front friction brake 104 is operatively connected to a respective front wheel 60, and each rear friction brake 105 is operatively connected to a respective rear wheel 62. As will be described below, in certain conditions, in response to the pressure in the hydraulic circuit 101 increasing, the front and rear friction brakes 104, 105 may be configured to apply braking torques to their respective front and rear wheels 60, 62. In the present embodiment, the front and rear friction brakes 104, 105 are configured to apply braking torques via calipers that engage discs of the wheels 60, 62. It is contemplated that the front and rear friction brakes 104, 105 could apply braking torques differently.

Referring now to FIG. 2, the piston assembly 106 includes a housing 120, a piston 122 disposed in the housing 120 and a biasing element 124 also received in the housing 120.

In the present embodiment, the housing 120 is a cylinder 120, and will henceforth be referred to as such. Two chambers 130, 132 are defined in the cylinder 120 by the piston 122. The sizes of the chambers 130, 132 vary in response to a movement of the piston 122. The chamber 130 is hydraulically connected to the brake actuator 102, such that the chamber 130 contains hydraulic fluid. The chamber 132 contains the biasing element 124. In the present embodiment, the biasing element 124 is a spring 124. One end of the spring 124 is connected to the piston 122, and the other end of the spring 124 is connected to the cylinder 120. It is contemplated that in other embodiments, the biasing element 124 could be another type of biasing element. For example, the biasing element 124 may be a compressible gas.

The piston 122 includes a ferromagnetic element in the form of a magnet 140 connected thereto. In some embodiments, the magnet 140 could be replaced by another ferromagnetic material. In some embodiments, the piston 122 itself could be made of a ferromagnetic material. As will be described below, in certain conditions, in response to the brake actuator 102 being actuated, a position of the piston 122 may be offset from the neutral position.

The piston 122 has a neutral position when the brake actuator 102 is not being actuated. More specifically, when the braking system 100 is not in operation, the hydraulic oil in the chamber 130 and the biasing element 124 interact with one another to define the neutral position of the piston 122. As will be described below, the behavior of the piston 122 in response to the actuation of the brake actuator 102 can vary based on the mechanical properties of the biasing element 124.

The sensor 108 is disposed on the outer surface of the cylinder 120, proximate to the neutral position of the piston 122. In the present embodiment, the sensor 108 is a magnetic field sensor 108 that can sense the magnet 140. In the present embodiment, the sensor 108 is a Hall-effect sensor 108. The Hall-effect sensor 108 is configured to sense a change in the magnetic field of the magnet 140 based on the relative position between the Hall-effect sensor 108 and the magnet 140 (e.g., if the magnet 140 is offset from a neutral position). Being that the magnet 140 is disposed on the piston 122, a position of the piston 122 can therefore be determined from the Hall-effect sensor 108 and the magnet 140. The Hall-effect sensor 108 is communicatively connected to the controller 70. The Hall-effect sensor 108 is configured to transmit a signal indicative of a change in the detected magnetic field to the controller 70. In response to the signal, the controller 70 can control the motor 54 to operate it in the motor braking mode. It is contemplated that in other embodiments, the sensor 108 may be another type of sensor, such as, for example, a position sensor or a speed sensor connected to the piston 122 and communicatively connected to the controller 70.

As mentioned above, the motor 54 can also be part of the braking system 100 by operating in a motor braking mode, in which the motor 54 applies a motor braking torque. In the present embodiment, the motor braking mode is a regenerative braking mode in which the motor 54 acts as a generator and supplies energy to the battery 58. In embodiments where the motor 54 is an internal combustion engine, the motor braking mode is an engine braking mode in which the vehicle 50 slows down as a result of the retarding forces in the motor 54. It is contemplated that in embodiments where the motor 54 is an internal combustion engine, the controller 70 could additionally be configured to control a throttle opening of the vehicle 50 when the engine braking mode is engaged.

As mentioned above, actuation of the brake actuator 102 increases the pressure in the hydraulic circuit 101. The hydraulic circuit 101 defines a friction threshold pressure and a regeneration threshold pressure. The friction and regeneration threshold pressures can be referred to as predetermined pressures. The friction threshold pressure can be defined by various mechanical properties of the braking system 100 and the vehicle 50. The regeneration threshold pressure is defined at least in part by the mechanical properties of the biasing element 124. For example, increasing a stiffness of the biasing element 124 may increase the regeneration threshold pressure. As will be described below, depending on the configuration of the biasing element 124 and the braking system 100, the regeneration threshold pressure may be greater than or less than the friction threshold pressure.

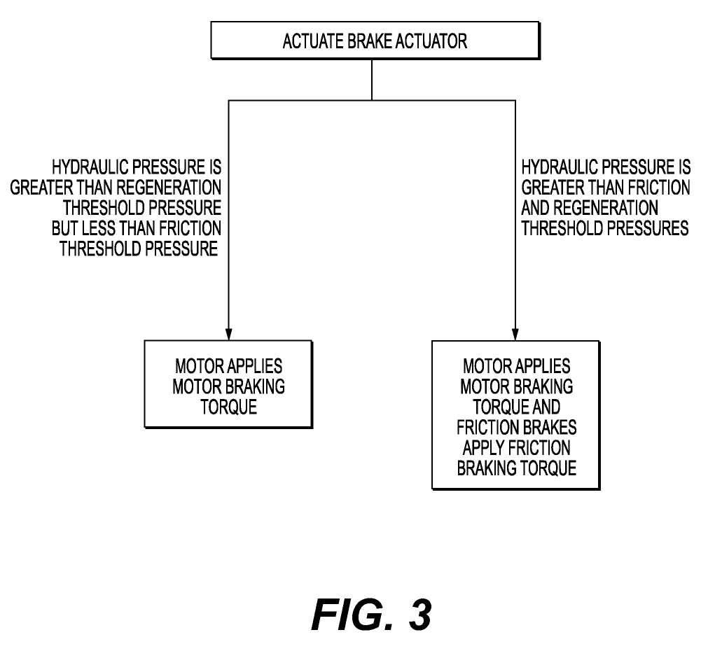

Referring to FIG. 3, a description of the braking system 100 according to one embodiment of the present technology will be described. In this embodiment, the friction threshold pressure is greater than the regeneration threshold pressure.

Actuation of the brake actuator 102 causes the pressure in the hydraulic circuit 101 to increase.

If the pressure in the hydraulic circuit 101 is less than the regeneration threshold pressure (and therefore less than the friction threshold pressure), then neither of the friction brakes 104, 105 nor the motor 54 apply a braking torque. In some embodiments, moving the brake actuator 102 by up to about 3% of its total range of motion may result in the pressure in the hydraulic circuit 101 remaining below the regeneration threshold pressure. It can be said that the pressure in the chamber 130 does not overcome the pressure resulting from the biasing element 124, and therefore does not cause movement of the piston 122.

If the pressure in the hydraulic circuit 101 is greater than the regeneration threshold pressure, but less than the friction threshold pressure, then the motor 54 applies a motor braking torque, but the friction brakes 104, 105 do not apply any friction braking torque.

More specifically, if the brake actuator 102 is actuated such that the pressure in the hydraulic circuit 101 is greater than the regeneration threshold pressure, then the pressure in the chamber 130 overcomes the pressure resulting from the biasing element 124, thereby causing the piston 122, and therefore the magnet 140, to be offset from the neutral position. Movement of the magnet 140 causes a change in the magnetic field position, which is detected by the Hall-effect sensor 108. The Hall-effect sensor 108 outputs a signal corresponding to the change in magnetic field and communicates it to the controller 70. Thus, the controller 70, based on the movement of the magnet 140, and therefore the movement of the piston 122, causes the motor 54 to operate in the regeneration mode, thereby applying a motor braking torque. If the pressure in the hydraulic circuit 101 has caused the piston 122 to move about half of its whole range of motion, then the controller 70 causes the motor 54 to apply half of the maximum motor braking torque. If the pressure in the hydraulic circuit 101 has caused the piston 122 to move across its whole range of motion, then the controller 70 causes the motor 54 to apply a maximum motor braking torque. It will therefore be appreciated that, according to the present technology, the motor braking torque applied by the motor 54 is variable. In the present embodiment, the motor braking torque is proportional to the position of the piston 122. It may not necessarily be a linear proportionality.

It will be noted that depending on the friction and regeneration threshold pressures and the configuration of the piston assembly 106, the friction brakes 104, 105 may begin to apply frictional braking torques before the piston 122 has travelled its whole range of motion (in such cases, the pressure in the hydraulic circuit 101 is greater than the regeneration threshold pressure and than the friction threshold pressure). For example, the piston assembly 106 may be configured such that the friction brakes 104, 105 begin applying frictional braking torques when the piston 122 has travelled 80% of its range of motion (i.e., the frictional braking torque starts to be applied when regeneration braking torque is applying 80% of the maximum braking torque).

It is contemplated that in alternative to, or in addition to, the motor braking torque applied by the motor 54 may vary according to a speed of the piston 122. For example, if the piston 122 moves away from the neutral position very quickly, the motor braking torque may apply a higher braking torque than if the piston 122 were to move away from the neutral position more slowly.

In some instances, a movement of the piston 122 across its whole range of motion may correspond to the movement of the brake actuator 102 of about 10% of its total range of motion.

If the pressure in the hydraulic circuit 101 is greater than the friction threshold pressure (and therefore greater than the regeneration threshold pressure), then the friction brakes 104, 105 and the motor 54 all apply a braking torque.

As mentioned above, depending on the regeneration and friction threshold pressures and the configuration of the piston assembly 106, the total applied braking torque may vary. For example, the friction threshold pressure may be greater than the regeneration threshold pressure, but less than the pressure required to move the piston 122 more than a predetermined ratio of its full range of motion. For example, the friction threshold pressure may be selected so that the friction brakes 104, 105 begin applying a frictional braking torque when the piston 122 has moved 80% of its range of motion. In such an instance, depending on the position of the piston 122, the controller 70 may operate the motor 54 in the regeneration mode at 80%.

Additionally, the pressure increase in the hydraulic circuit 101 causes the friction brakes 104, 105 to apply, via friction, braking torques to their respective wheels 60, 62. The braking torque applied by the friction brakes 104, 105 to the wheels 60, 62 can vary based on a magnitude of the pressure in the hydraulic circuit 101. For example, if the pressure in the hydraulic circuit 101 is slightly higher than the friction threshold pressure, then the friction brakes 104, 105 might apply less braking torque than if the pressure in the hydraulic circuit 101 is considerably higher than the friction threshold pressure.

It will be appreciated that in this embodiment, the brake actuator 102 can cause operation of the friction brakes 104, 105 and also cause operation of the motor 54 to operate in the motor braking mode.

In some scenarios, for example if the battery is fully charged, the controller 70 may be configured to bypass the motor braking.

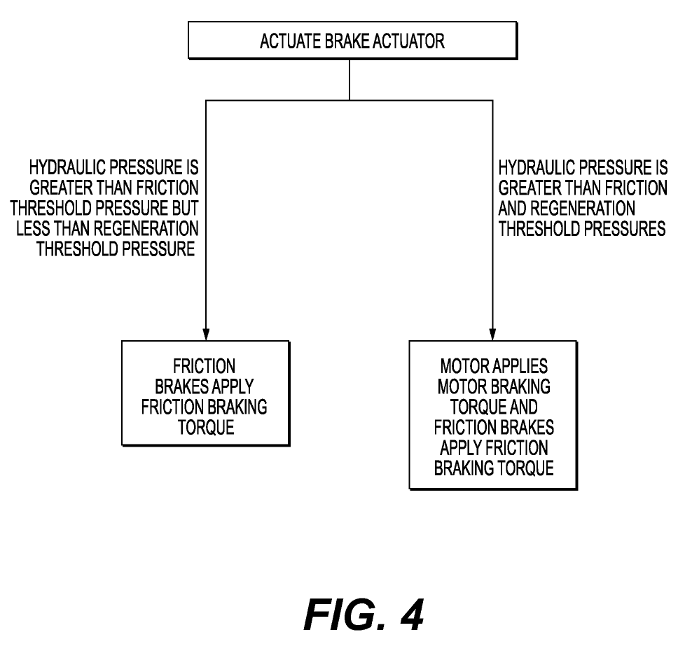

Referring to FIG. 4, a description of an alternative embodiment of the braking system 100 will now be provided. In this embodiment, the friction threshold pressure is less than the regeneration threshold pressure.

As in the previous embodiment, actuation of the brake actuator 102 causes the pressure in the hydraulic circuit 101 to increase.

If the pressure in the hydraulic circuit 101 is less than the friction threshold pressure (and therefore less than the regeneration threshold pressure), then neither of the friction brakes 104, 105 nor the motor 54 apply a braking torque, as described above.

If the pressure in the hydraulic circuit 101 is greater than the friction threshold pressure, but less than the regeneration threshold pressure (i.e., the spring 124 is stiffer than in embodiment 3), then the friction brakes 104, 105 apply a friction braking torque, but the motor 54 does not apply a motor braking torque.

More specifically, the hydraulic pressure causes the friction brakes 104, 105 to apply, via friction, braking torques to their respective wheels 60, 62. However, the pressure in the chamber 130 does not cause movement of the piston 122.

If the pressure in the hydraulic circuit 101 is greater than the regeneration threshold pressure (and therefore greater than the friction threshold pressure), then the friction brakes 104, 105 and the motor 54 all apply a braking torque.

As described above with reference to FIG. 3, depending on the regeneration threshold pressure and the friction threshold pressure, the total applied braking torque may vary. For instance, the regeneration threshold pressure may be greater than the friction threshold pressure, but less than the pressure required to apply a predetermined amount of frictional braking torque. For example, the regeneration threshold pressure could be selected so that the motor 54 begins applying a motor braking torque once the friction brakes 104, 105 are applying 20% of their maximum frictional braking torque. In this case, since the pressure in the hydraulic circuit 101 is greater than the friction threshold pressure, the hydraulic fluid has caused the friction brakes 104, 105 to apply the predetermined friction braking torque. Additionally, the pressure in the chamber 130 has caused movement of the piston 122, which, as described above, causes the motor 54 to apply a motor braking torque.

In this embodiment, operation of the friction brakes 104, 105 can assist in keeping the components of the braking system free of rust or other contaminants, which can otherwise become a problem if the friction brakes 104, 105 are seldom used.

Modifications and improvements to the above-described implementations of the present technology may become apparent to those skilled in the art. The foregoing description is intended to be exemplary rather than limiting.

What is claimed is:

1. A braking system comprising:
a brake actuator;
a first brake hydraulically connected to the brake actuator, the first brake being configured to apply a first braking torque;
a piston assembly comprising:
a housing;
a piston disposed within the housing, the piston defining:
a first chamber in the housing, the first chamber being hydraulically connected to the brake actuator; and
a second chamber in the housing, and
a biasing element biasing the piston toward a neutral position,
a sensor sensing a position of the piston;
a second brake communicatively connected to the sensor, the second brake being configured to apply a second braking torque,
a hydraulic circuit defined by the brake actuator, the first brake, and the piston assembly, and in response to the brake actuator being actuated, a pressure in the hydraulic circuit increases,
in response to the pressure of the hydraulic circuit being greater than a first predetermined pressure, the first brake applies the first braking torque; and
in response to the pressure of the hydraulic circuit being greater than a second predetermined pressure, the piston is offset from the neutral position, the second brake applies the second braking torque.

2. The braking system of claim 1, wherein the first braking torque is variable.

3. The braking system of claim 2, wherein the first braking torque varies according to the pressure in the hydraulic circuit.

4. The braking system of claim 1, wherein the second braking torque is variable.

5. The braking system of claim 4, wherein the second braking torque varies according to a movement of the piston.

6. The braking system of claim 5, wherein the second braking torque varies proportionally to the movement of the piston.

7. The braking system of claim 4, wherein the second braking torque varies according to a speed of the piston.

8. The braking system of claim 7, wherein the second braking torque varies proportionally to the speed of the piston.

9. The braking system of claim 1, wherein the second predetermined pressure is in part defined by the biasing element.

10. The braking system of claim 1, wherein the second predetermined pressure is greater than the first predetermined pressure.

11. The braking system of claim 1, wherein the second predetermined pressure is less than the first predetermined pressure.

12. The braking system of claim 1, wherein the first brake is a friction brake configured to operatively connect to a wheel.

13. The braking system of claim 12, wherein:
the friction brake is a first friction brake, and
the braking system further includes a second friction brake hydraulically connected to the brake actuator, the second friction brake being configured to operatively connect to an other wheel.

14. The braking system of claim 1, wherein the second brake is a motor brake.

15. The braking system of claim 14, wherein the motor brake comprises:
an electric motor;
an inverter; and
a battery, and
the second braking torque is applied by the electric motor being operated as a generator to recharge the battery.

16. The braking system of claim 14, wherein the motor brake comprises an internal combustion engine configured to apply retarding forces.

17. The braking system of claim 1, wherein:
the piston has a ferromagnetic element, and
the sensor is a Hall-effect sensor for detecting the position of the piston via the ferromagnetic element.

18. The braking system of claim 1, wherein the biasing element is a spring.

19. The braking system of claim 1, wherein the biasing element is disposed in the second chamber.
